(19) United States
(12) Patent Application Publication
(10) Pub. No.: US 2026/0222346 A1
(43) Pub. Date: Jul. 30, 2026

(54) WINDOW-BASED CONGESTION CONTROL

(71) Applicant: Intel Corporation, Santa Clara, CA (US)

(72) Inventors: Naveed ALAM, Bangalore (IN); Robert SOUTHWORTH, Chatsworth, CA (US)

(21) Appl. No.: 19/574,014

(22) Filed: Mar. 20, 2026

Related U.S. Application Data
(63) Continuation-in-part of application No. 18/082,749, filed on Dec. 16, 2022.

(51) Int. Cl. H04L 47/12; H04L 43/10; H04L 67/1097

(52) U.S. Cl. CPC H04L 47/12; H04L 43/10; H04L 67/1097

(57) ABSTRACT

Examples described herein relate to a network interface device. The network interface device includes a host interface; a network interface; a direct memory access (DMA) circuitry; and a circuitry. In some examples, the circuitry is to control a transmission rate of packets based on a transmitted Inband Flow Analyzer (IFA) probe packet and a received IFA probe response packet. In some examples, the IFA probe response packet includes information utilized to control the transmission rate of packets and the packets are transmitted in a manner consistent with a protocol that does not specify use of explicit acknowledgements of receipt (ACKs) and does not specify use of congestion windows.

### RELATED APPLICATION

The present application is a continuation-in-part of U.S. patent application Ser. No. 18/082,749, filed Dec. 16, 2022 (Attorney Docket Number AE6187-US). The contents of that application are incorporated herein in their entirety.

### BACKGROUND

Data center networking connects servers, storage, and cloud resources through physical hardware (e.g., switches, routers, and network interface devices). Networks use congestion control to regulate data traffic, preventing network overload, and reducing packet loss. Network congestion control avoids overburdening available network bandwidth by limiting a flow's transmission rate, outstanding unacknowledged packets, or both.

### BRIEF DESCRIPTION OF THE DRAWINGS

FIG. 1 depicts an example system.

FIG. 2 depicts an example packet format.

FIGS. 3A and 3B depict examples of packet formats.

FIG. 4 depicts an example process.

FIGS. 5A and 5B depict example network interface devices.

FIG. 6 depicts an example network interface device.

FIG. 7 depicts an example system.

### DETAILED DESCRIPTION

J. Kumar et al., “Inband Flow Analyzer,” Network Working Group (2024) defines Inband Flow Analyzer (IFA) probe packets used for collecting telemetry information from a network that transfers packets to a recipient. Various examples can transmit IFA probe packets to carry information for window-based congestion control at least for packet transmissions utilizing the Remote Direct Memory Access (RDMA) over Converged Ethernet (RoCEv2) protocol. Various examples include a packet format for an IFA probe packet and IFA probe response packet. A packet sender can include information for window-based congestion control in the IFA probe packet, such as timestamp of transmission of the IFA probe packet, number of bytes sent to a receiver, or other information. The intermediate forwarding elements can inject information for window-based congestion control into the IFA probe packet, and per-hop telemetry information such as one or more of: queue depth, ingress port speed, egress port speed, residence time in a forwarding element, link utilization, number of flows that provide packets to a congested queue, most congested queue depth in forwarding elements along a path from a sender to receiver, most congested forwarding element identifier (ID), or others.

The receiver network interface device can copy the information and the telemetry information from the IFA probe packet into an IFA probe response packet and send the IFA probe response packet to the sender. The IFA probe packet can indicate use of RoCEv2 protocol to transmit the packet in a User Datagram Protocol (UDP) header. IFA probe and IFA response packets can control a number of in-flight bytes transmitted from the sender to a receiver for a particular RDMA queue pair (QP). Embedding the information for congestion control in the IFA probe packets can avoid use of additional notification packets.

The sender can apply a congestion control scheme to adjust a rate of transmission of packets. For example, High Precision Congestion Control (HPCC) or HPCC++ can be used to control the number of inflight bytes. HPCC is described at least in Y. Li et al. “HPCC: high precision congestion control.” In: Proceedings of ACM SIGCOMM (2019) and earlier drafts, later drafts, and variations thereof. HPCC++ is described at least in Miao et al., “HPCC++: Enhanced High Precision Congestion Control,” Internet Engineering Task Force (IETF) (2024) and earlier drafts, later drafts, and variations thereof.

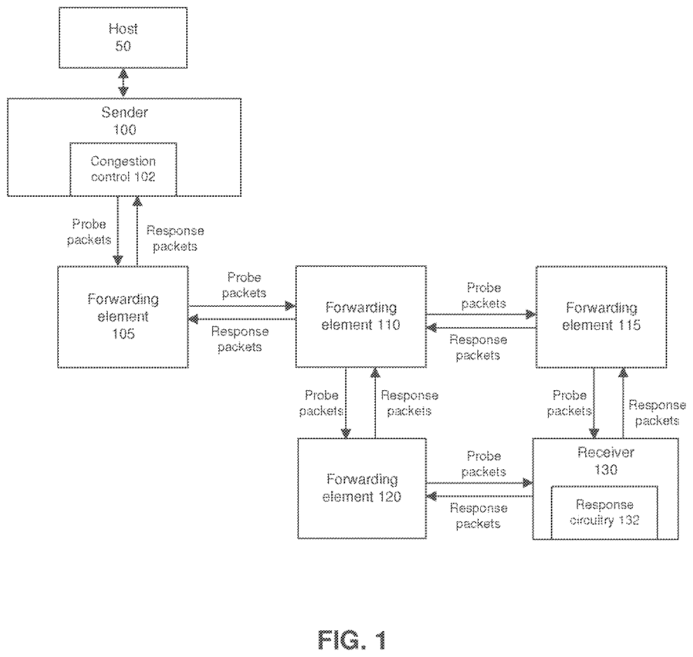

FIG. 1 depicts an example system. Sender network device 100 can include a network interface device that sends one or more packets to receiver network device 130, via one or more forwarding elements, such as forwarding elements 105, 110, and 115, at a request of host system 50. Packets can traverse one or more paths through forwarding elements to receiver network device 130. Sender network device 100 can transmit data packets, control packets, IFA probe packets, and/or IFA probe response packets to receiver network device 130. Data packets, control packets, IFA probe packets, and/or IFA probe response packets can be transmitted in a manner consistent at least with remote direct memory access (RDMA) over Converged Ethernet (RoCE) v2. For example, RoCEv2 is described at least in Annex A17: RoCEv2 (2014). Note that protocols other than RDMA or RoCEv2 can be used to transmit packets, IFA probe packets, and/or IFA probe response packets, such as Internet Wide Area RDMA Protocol (iWARP), quick User Datagram Protocol (UDP) Internet Connections (QUIC), InfiniBand, and others.

In some examples, a network interface device can refer to one or more of: a network interface controller (NIC), a remote direct memory access (RDMA)-enabled NIC, SmartNIC, router, switch, infrastructure processing unit (IPU), data processing unit (DPU), or network-attached appliance. In some examples, forwarding elements 105, 110, and/or 115 can be implemented as one or more of: network interface controller (NIC), SmartNIC, router, top of rack (ToR) switch, switch, infrastructure processing unit (IPU), or data processing unit (DPU).

A packet may be used herein to refer to various formatted collections of bits that may be sent across a network, such as Ethernet frames, Internet Protocol (IP) packets (e.g., IPv4 or IPv6), Transmission Control Protocol (TCP) segments, User Datagram Protocol (UDP) datagrams, etc. A flow can be a sequence of packets being transferred between two endpoints, generally representing a single session using a protocol. Accordingly, a flow can be identified by a set of defined tuples and, for routing purpose, a flow is identified by the two tuples that identify the endpoints, e.g., the source and destination addresses. For content-based services (e.g., load balancer, firewall, Intrusion detection system etc.), flows can be identified at a finer granularity by using N-tuples (e.g., source IP address, destination IP address, IP protocol, transport layer source port, or destination port). A packet in a flow can have the same set of tuples in the packet header. A packet flow to be controlled can be identified by a combination of tuples (e.g., Ethernet type field, source IP address, destination IP address, source media access control (MAC) address, destination MAC address, source User Datagram Protocol (UDP) port, destination UDP port, source TCP port, destination TCP port, or any other header field) and a unique queue pair (QP) number or identifier.

Reference to flows can instead or in addition refer to tunnels (e.g., Multiprotocol Label Switching (MPLS) Label Distribution Protocol (LDP), Segment Routing over IPv6 data plane (SRv6) source routing, VXLAN tunneled traffic, GENEVE tunneled traffic, virtual local area network (VLAN)-based network slices, technologies described in Mudigonda, Jayaram, et al., “Spain: Cots data-center ethernet for multipathing over arbitrary topologies,” NSDI. Vol. 10. 2010 (hereafter “SPAIN”), and so forth.

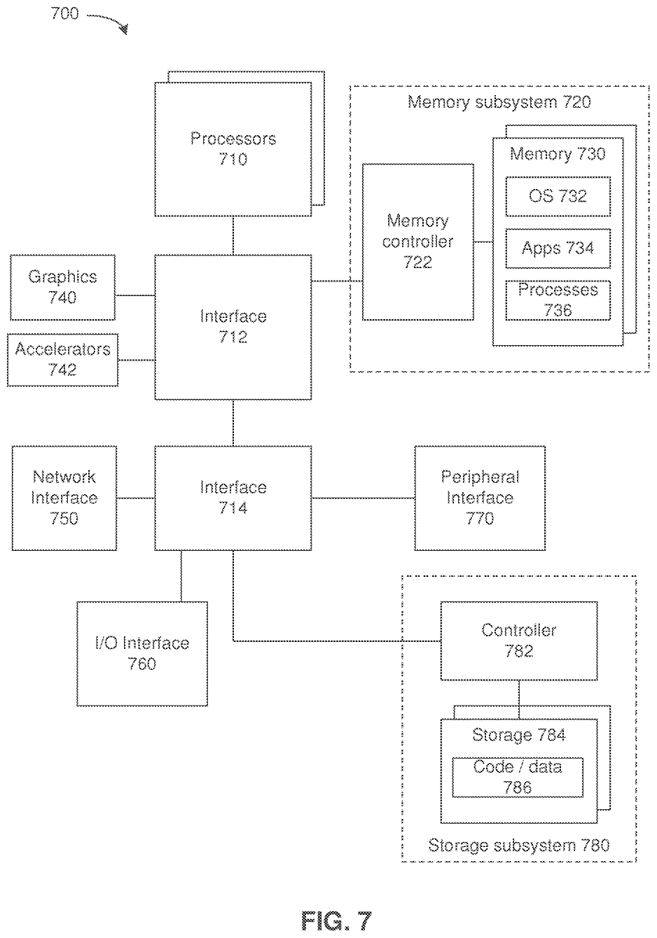

Host 50 can execute an operating system (OS) or driver that configures sender network device 100 to send IFA probe packets and process IFA probe response packets to perform congestion control at least for communications consistent with RoCEv2. Various examples of host 50 are described herein, at least with respect to FIG. 7. The OS or driver can advertise capability of sender network device 100 to send IFA probe packets and process IFA probe response packets to perform congestion control at least for communications consistent with RoCEv2. The OS or driver can call an application programming interface (API) to enable or disable the capability.

After a certain number of bytes of data (ByteThreshold) are sent for a particular QP, sender network device 100 can send an IFA probe packet to collect telemetry information from a forwarding element path of the data packets to receiver 130. IFA probe packets can carry the then-current count of sent packets (send_cnt) and a timestamp of transmission of a IFA probe packet. IFA probe packets can follow the same path through the network to receiver network device 130 as the data packets transmitted before them, and stay in order behind them. In some examples, IFA probe packets can carry data to receiver 130 also. In some examples, ByteThreshold can be a multiple of bytes, such as a 64 bytes or 32 bytes, or other values. In some examples, sender network device 100 can send an IFA probe packet approximately one or more times per round trip time (RTT), approximately after M transmitted data and/or control packets, where M is configured by a driver for congestion control 102, or based on a number of in-flight packets.

Sender network device 100 can utilize congestion control circuitry 102 to track a number of payload bytes sent on a given RDMA QueuePair (QP) as data send_cnt. In some examples, transmitted bytes, including re-transmitted bytes, can be tracked. The data send_cnt counts RoCE data payload bytes transmitted in a same path to receiver network device 130, including Read Responses, Sends, and Writes. In some examples, send_cnt does not count a number of header bytes, but instead, a fixed byte count per packet represents a size of a header. Bytes can be measured rather than packets to account for variability of packet sizes.

For congestion control for RoCEv2 packets, an IFA probe packet can use the format defined for Internet Protocol v4 (IPv4) or Internet Protocol v6 (IPv) packets, with an Internet Assigned Numbers Authority (iANA) allocated UDP Destination port for RoCEv2. The bA probe packet can use the same header encapsulation (including the UDP source port, used by RoCEv2), and be placed in the same traffic class or different traffic class as those of the data packets. IFA probe packets can be transmitted after or intermixed with data packets sent to receiver 130.

IFA probe packets can collect congestion telemetry information from forwarding elements. Based on receipt of the IFA probe packets, receiver network device 130 can send the probe responses, echoing the telemetry information the probe packet collected in the path from the sender to the receiver. Telemetry information can include at least the following, or none of them.

| | |
|---|---|
| IP TTL | IP time-to-live value at each hop. |
| Egress Port Speed | Egress port speed is mapped with the IFA metadata. Encodings can be |
| | at least 0-10 Gbps, 1-25 Gbps, 2-40 Gbps, 3-50 Gbps, 4-100 Gbps, 5- |
| | 200 Gbps, and 6-400 Gbps. For example, if an egress port speed is |
| | 40 Gbps, the speed field of the IFA packet is set to 2. |
| Congestion | Indicates whether the packet has experienced congestion in a |
| | forwarding element. |
| Queue ID | Egress port queue identifier (ID). |
| Rx Timestamp Seconds | Received packet timestamp. |
| Egress Port Number | Egress hardware port number. |
| Ingress Port Number | Ingress hardware port number. |
| Rx Timestamp | Received timestamp. |
| Nanoseconds | |
| Residence Time | Per-hop latency. |
| Nanoseconds | |
| Egress queue | Egress queue transmission bytes. |
| transmission bytes | |
| Packet queue depth | Depth of the packet queue in a forwarding element. |
| Queue pool available | Queue pool available in a forwarding element. |

Embedding the telemetry information in the IFA probe packets can avoid using additional notification packets to convey telemetry information used for congestion control. Use of IFA probe packets can reduce network overhead, particularly in comparison to using InfiniBand consistent management packets for window tracking, which are defined to have a fixed 256B payload.

When an IFA probe packet arrives at receiver network device 130, data packets sent before the IFA probe packet have either arrived at receiver network device 130 or were dropped. In response to receipt of the IFA probe packets, receiver network device 130 can send a response to the IFA probe along the same path of forwarding elements that forwarded the IFA probe packet or a different path, and can include in the response at least one or more of: the telemetry information received in the probe packet, which was collected in the path of forwarding elements from sender network device 100 to the receiver network device 130, send_cnt from the IFA probe packet, transmit timestamp from the IFA probe packet, local response latency of forwarding elements in the IFA probe response packet in order to exclude the response latency from RTT measured by congestion control 102, or others.

Receiver network device 130 can include a network interface device that received one or more RoCEv2 packets from sender network device 100. Receiver network device 130 can be coupled to a host system (not shown, but an example of a host system is described with respect to FIG. 7). Receiver network device 130 can utilize response circuitry 132 in a network interface device and/or host to process received IFA probe packets and generate IFA response packets to transmit to sender network device 100. Response circuitry 132 can be implemented as one or more of: an FPGA, an accelerator, (ASIC), or instruction-executing processor.

Sender network device 100 can utilize congestion control 102 to measure differences between a current timestamp value, in a time domain of sender 100, and a timestamp value received from IFA probe response packet, to determine if a path from sender 100 to receiver 130 is becoming more congested, less congested, or congestion remains the approximately the same or within a range. Congestion levels in a path can be affected by queue depth of one or more forwarding elements in a path, which can lead to latency of packet traversal to receiver 130 or packet drops. As a path of IFA probe response packets from receiver 130 to sender 100 can provide an approximately constant level of latency via a higher priority class, changes in congestion and latency of a path from receiver network device 130 to sender network device 100 can be approximated from differences between timestamp values at transmission of one or more IFA probe packets from sender network device 100 and timestamp values at receipt of IFA probe response packets that carry transmission timestamp values of the one or more IFA probe packets.

Based on receipt of the IFA probe response, sender network device 100 can utilize congestion control circuitry 102 in network interface device and/or a host to determine a round trip time (RTT) based on timestamp differences between an IFA probe packet and receipt of the IFA probe response packet, such as using the transmit timestamp of an IFA probe and a timestamp at which the IFA probe response is received. Congestion control circuitry 102 can perform congestion control by adjusting a window size to control a rate of packet transmissions based on the calculated RTT. Sender network device 100 can adjust a window size based on queue depth or hop latency. Window-based congestion control is a network traffic management technique, where the sender limits the amount of unacknowledged data in transit based on a size of a congestion window.

Congestion control 102 can identify changes in RTT to identify changes in queue depths and congestion of forwarding elements. An increasing RTT value can indicate increasing congestion in a path from sender network device 100 to receiver network device 130. A decreasing RTT value can indicate decreasing congestion in a path from sender network device 100 to receiver network device 130. Congestion control 102 can adjust a congestion window size based on changes to RTT. For example, congestion window size can be increased to a congestion window ceiling based on the RTT being stable or falling. For example, congestion window size can be decreased to a congestion window floor based on a rising RTT.

Sender network device 100 can determine a number of payload bytes not yet received (e.g., not yet acknowledged) by receiver 130 based on a difference between current send count and send count previously sent in an IFA probe packet. Sender network device 100 can send data if its current send count minus the most recently echoed back send count (sent by the receiver in the IFA probe response) is less than the current window, which is calculated by a congestion control algorithm. Otherwise, sender network device 100 can stop sending data and wait for a new probe response before sending data again.

Based on a number of payload bytes not yet received (e.g., not acknowledged yet) by receiver 130 increasing, congestion control 102 can reduce the congestion window size. Based on a number of payload bytes not yet received (e.g., not acknowledged yet) by receiver 130 decreasing, congestion control 102 can increase the congestion window size. If round trip time and a number of payload bytes not yet received (not acknowledged yet) by receiver are unchanged, congestion control 102 can maintain the congestion window size.

Congestion control circuitry 102 can update the congestion window, cwnd, that limits a number of outstanding transmitted bytes for which acknowledgement of receipt has not been received. A congestion window can represent a number of packets or amount of data (e.g., number of bytes) that can be transmitted before receipt of an acknowledgement of packet receipt.

In some examples, instead of including data (e.g., amount of bytes sent since a prior IFA probe packet was sent, an accumulated amount of bytes sent, and/or a timestamp of transmission of the one or more data packets), in the IFA probe packet, the data can be saved at sender network device 100 or a memory accessible to sender network device 100, and the IFA probe packet or data or control packet can include an indicator (e.g., table index value) associated with the data. The indicator could be sent in a header field of the IFA probe packet and a header field of the IFA probe response packet or other packet. Sender network device 100 could use the received indicator to look up the data based on receipt of the IFA probe response packet or other packet. Such examples can be used in a variety of scenarios including where the IFA probe packet and its data are indicated in a field of one or more data packet headers.

In some examples, congestion control circuitry 102 can apply Data Center Quantized Congestion Notification (DCQCN) to control transmit rate of packets based on cseq returned in one or more RNPs. See, e.g., Y. Hu, Z. Shi, Y. Nie and L. Qian, “DCQCN Advanced (DCQCN-A): Combining ECN and RTT for RDMA Congestion Control,” 2021 IEEE 5th Information Technology, Networking, Electronic and Automation Control Conference (ITNEC), 2021, pp. 1192-1198.

In some examples, congestion control 102 can utilize High Precision Congestion Control (HPCC), HPCC++, or in-network telemetry (INT) for remote direct memory access (RDMA) communications that provides congestion metrics to convey link load information. For example, one or more forwarding elements and/or sender network device 100 can transmit cseq or timestamps to receiver 130 based on HPCC or HPCC++.

In some examples, network telemetry data can include data described at least in: “In-band Network Telemetry (INT) Dataplane Specification, v2.0,” P4.org Applications Working Group (February 2020); Alternate-Marking Method for Passive and Hybrid Performance Monitoring (AM-PM) (e.g., Internet Engineering Task Force (IETF) RFC 9341 (2022); IETF draft-lapukhov-dataplane-probe-01, “Data-plane probe for in-band telemetry collection” (2016); and IETF draft-ietf-ippm-ioam-data-09, “In-situ Operations, Administration, and Maintenance (IOAM)” (Mar. 8, 2020). In-situ Operations, Administration, and Maintenance (IOAM) records operational and telemetry information in the packet while the packet traverses a path between two points in the network. IOAM discusses the data fields and associated data types for in-situ OAM. In-situ OAM data fields can be encapsulated into a variety of protocols such as NSH, Segment Routing, Geneve, IPv6 (via extension header), or IPv4.

Congestion control 102 can apply other TCP congestion control schemes including Google's Swift, Amazon's SRD, and Microsoft's Data Center TCP (DCTCP), described for example in RFC 8257 (2017). DCTCP is a TCP congestion control scheme whereby when a buffer reaches a threshold, packets are marked with ECN and the end host receives markings and sends the marked packets to a sender. In response to an ECN, sender 100 can reduce a congestion window size to reduce a number of sent packets for which acknowledgement of receipt was not received. Swift, SRD, DCTCP, and other CC schemes adjust a congestion window size based on indirect congestion metrics such as packet drops or network latency.

For some applications, the underlying transport layer is Transmission Control Protocol (TCP). Multiple different congestion control (CC) schemes can be utilized for TCP. Explicit Congestion Notification (ECN), defined in RFC 3168 (2001), allows end-to-end notification of network congestion whereby the receiver of a packet echoes a congestion indication to a sender. A packet sender network device 100 can reduce its packet transmission rate in response to receipt of an ECN. Use of ECN can lead to packet drops if detection and response to congestion is slow or delayed. For TCP, congestion control 102 can apply congestion control based on heuristics from measures of congestion such as network latency or the number of packet drops.

Congestion control circuitry 102 can be implemented as one or more of: field programmable gate array (FPGA), an accelerator, application specific integrated circuit (ASIC), or instruction-executing processor.

For example, one or more forwarding elements and/or sender network device 100 can transmit send_cnt, timestamps, or other telemetry to receiver 130 based on In-band Network Telemetry (INT) (e.g., P4.org Applications Working Group, “In-band Network Telemetry (INT) Dataplane Specification,” Version 1.0 (2018)); Round-Trip-Time (RTT) probes; acknowledgement (ACK) messages; IETF draft-lapukhov-dataplane-probe-01, “Data-plane probe for in-band telemetry collection” (2016); or IETF draft-ietf-ippm-ioam-data-09, “In-situ Operations, Administration, and Maintenance (IOAM)” (Mar. 8, 2020). IOAM records operational and telemetry information in the packet while the packet traverses a path between two points in the network. IOAM discusses the data fields and associated data types for in-situ OAM. In-situ OAM data fields can be encapsulated into a variety of protocols such as Segment Routing, Geneve, IPv6 (via extension header), or IPv4. For example, one or more switches and/or receiver 130 can transmit cseq or timestamps to sender 100 based on techniques utilized by sender 100 to transmit cseq or timestamps.

While examples are described with respect to the IFA protocol, other protocols can be used such as protocols that do not prescribe use of a congestion window and/or a receiver does not send explicit acknowledgements of packet receipt (ACKs). For example, protocols that do not use congestion windows include TIMELY, User Datagram Protocol (UDP), InfiniBand, or others. For example, a receiver can send an explicit or implicit ACK to a sender of a packet indicate receipt of the packet. An explicit ACK can include a separate packet or signal sent by a receiver to confirm to the sender the successful, error-free receipt of the packet. By contrast, an implicit ACK can include a receipt of data in response to a sent packet requesting the data.

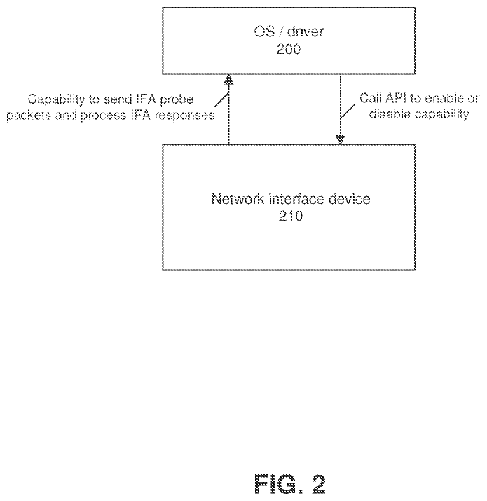

FIG. 2 depicts an example of configuration of a network interface device.

Configuration of a network interface device can be consistent with versions of Network Driver Interface Specification (NDIS), Network Adapter Class Extension (NetAdapterCx), or others. For example, network interface device 210 can advertise capabilities to send IFA probe packets and process IFA probe response packets to perform congestion control at least for communications consistent with RoCEv2. Operating system (OS) or driver 200 can enable or disable the capabilities by calling an API.

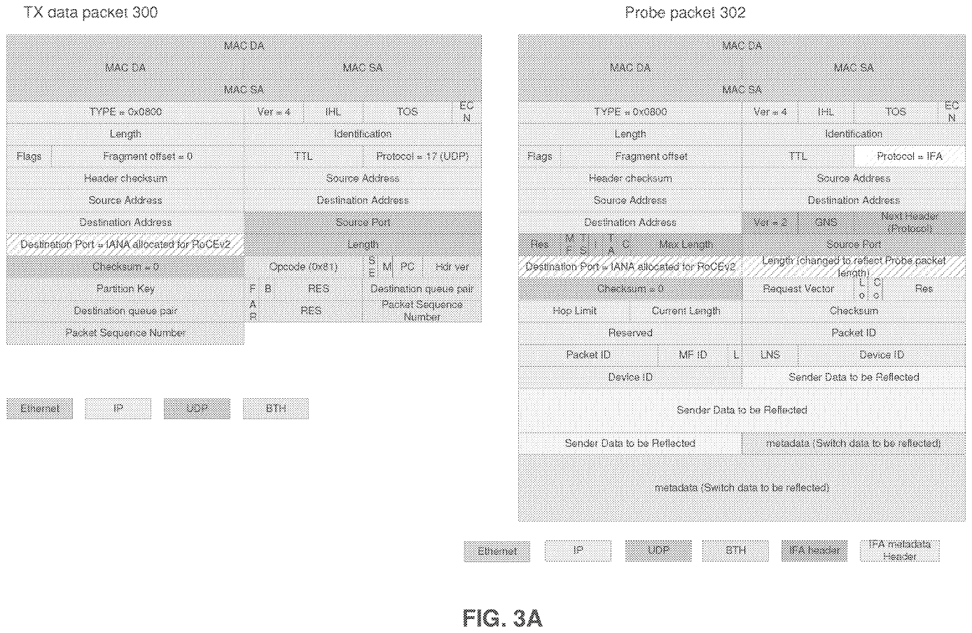

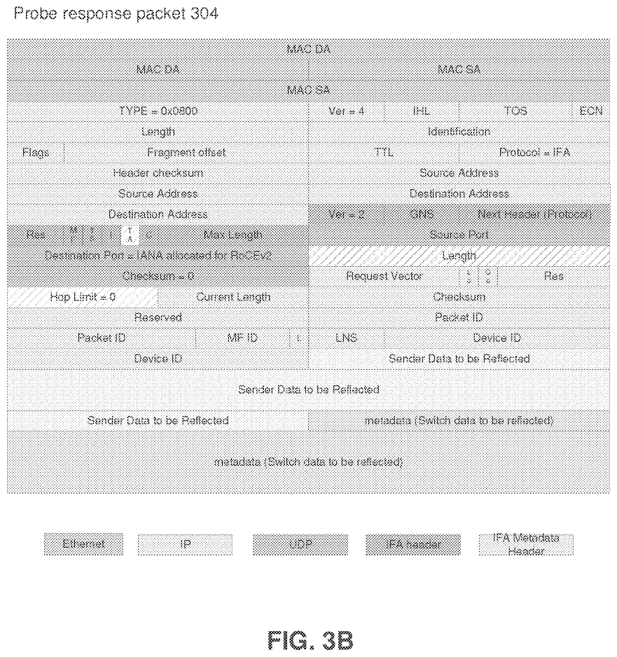

FIG. 3A depicts an example packet format of a data packet and an IFA probe packet. Data packet 300 can include Ethernet header fields, IP header fields (e.g., IPv4 or IPv6), UDP header fields, and Base Transport Header (BTH) header fields for InfiniBand and RoCE protocols. In this example, data packet 300 can utilize a RoCEv2 protocol and the UDP header fields can specify a destination port that is an Internet Assigned Numbers Authority (IANA) allocated for RoCEv2 traffic.

Probe packet 302 can include the Ethernet header, IP header, and UDP header from data packet 300. However, in probe packet 302, a length field in the UDP header can be changed to reflect a length of probe packet 302. An IFA header can be inserted into probe packet 302, as well as sender telemetry data and telemetry metadata determined at forwarding elements from a path from sender network device to receiver network device. IFA probe packets may not be RoCEv2 packets but arrive at a same destination port as RoCEv2 packets.

FIG. 3B depicts an example packet format of an IFA response packet. Probe response packet 304 can include IP header fields, UDP header fields, and IFA header fields from probe packet 302 but with destination and source addresses and ports reversed as the probe response packet travels from the destination to the source. In the IFA header field, the turn around (TA) bit can be cleared to prevent generation of a response to the probe response. In the UDP header field, the length field can be updated to reflect a length of the IFA probe response. The length may change if a receiver adds content to response. In the IFA metadata header field, the hop limit can be changed to 0 so that forwarding elements do not insert telemetry data into the IFA probe response. The sender metadata and switch metadata from the IFA probe packet can be sent back to the sender.

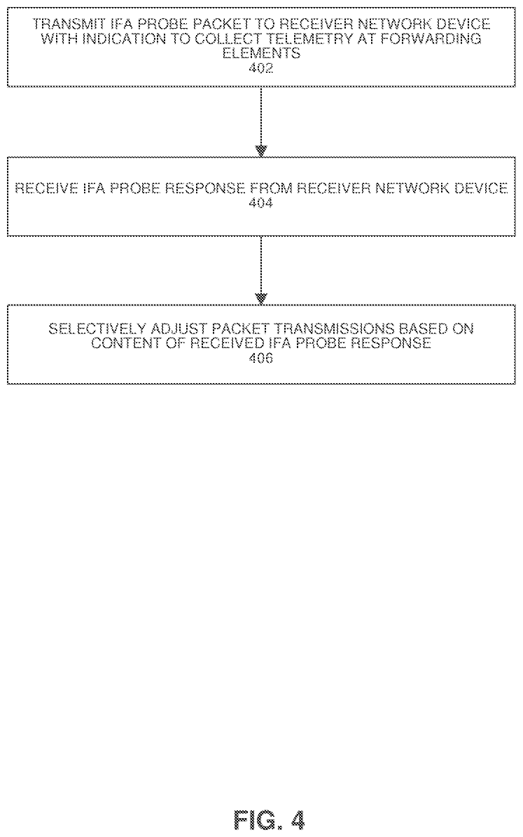

FIG. 4 depicts an example process. At 402, a sender network device can send a IFA probe packet with accumulated transmitted byte count and timestamp of transmission of the IFA probe packet among or after transmitted data traffic to a receiver network device. In some examples, the accumulated transmitted byte count can represent a number of bytes transmitted to the receiver or a number of bytes transmitted to the receiver since a previous notification packet was sent. In some examples, the IFA probe packet can be transmitted along a same path as data and/or control traffic to the receiver network device. Based on an indication in the IFA probe packet to accumulate telemetry data in the IFA probe packet, forwarding elements that receive and forward the IFA probe packet to the receiver can insert telemetry data into the IFA probe packet prior to forwarding the IFA probe packet to the receiver network device.

At 404, the sender network device can receive an IFA probe response, from the receiver network device, with a copy of the accumulated transmitted byte count, timestamp of transmission of the IFA probe packet, and telemetry collected by the IFA probe packet from forwarding elements along a path from the sender network device to the receiver network device. The IFA probe response may not include telemetry of forwarding elements along the path from the receiver network device to the sender network device.

At 406, the sender network device can adjust the congestion window based on changes in network latency. Network latency can be determined based on one or more of: RTT, available bytes to send, and/or telemetry collected by the IFA probe packet from forwarding elements along a path from the sender network device to the receiver network device. The sender network device can calculate the RTT based on the timestamp of transmission of the IFA probe packet and the timestamp of receipt of the IFA response packet. For example, a rising RTT can indicate increasing latency and congestion in the path from sender to receiver. For example, a falling RTT can indicate decreasing latency and congestion in the path from sender to receiver. For example, congestion window size can be increased to a congestion window ceiling based on the RTT being stable or falling. For example, congestion window size can be decreased to a congestion window floor based on a rising RTT. Other manners of adjusting congestion window size or rate of transmission of packets can be utilized.

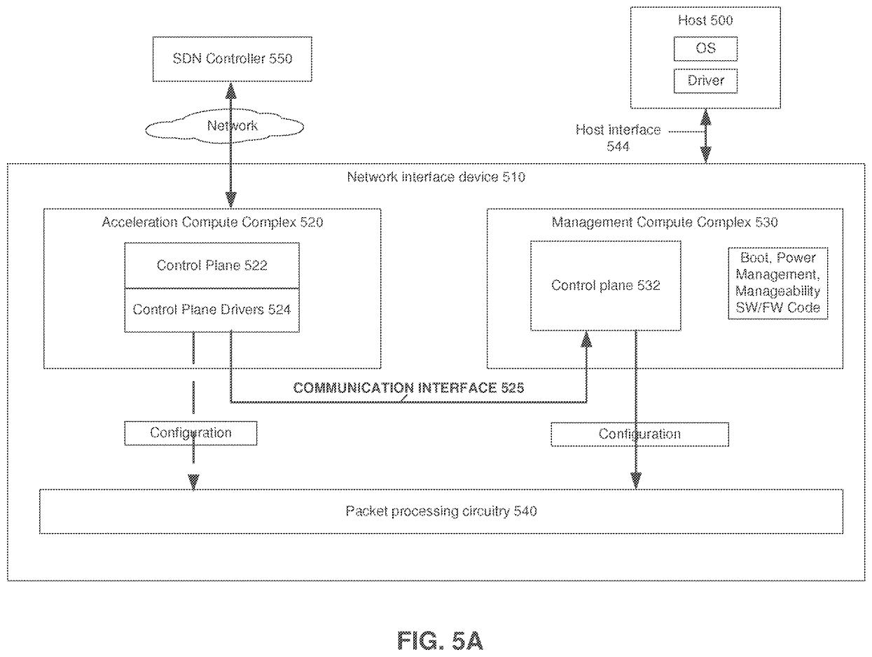

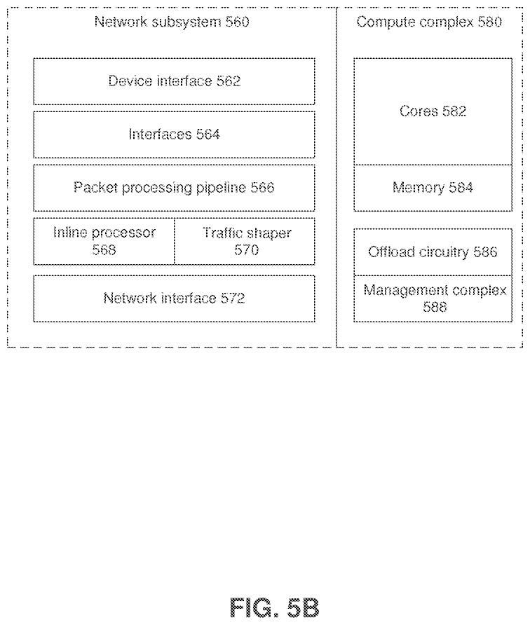

FIG. 5A depicts an example system. Host 500 can include processors, memory devices, device interfaces, as well as other circuitry such as described with respect to other figures. Processors of host 500 can execute software such as processes (e.g., applications, microservices, virtual machine (VMs), microVMs, containers, processes, threads, or other virtualized execution environments), operating system (OS), and device drivers. An OS or device driver can configure network interface device or packet processing device 510 to utilize one or more control planes to communicate with software defined networking (SDN) controller 550 via a network to configure operation of the one or more control planes. Host 500 can be coupled to network interface device 510 via a host or device interface 544.

Host 500 can configure network interface device 510 to perform rate control at least for transmission of RoCEv2 packets based on information received from IFA probe response packets, as described herein.

Communication interface 525 and/or device interface 544 can be configured as a PCIe switch or host interface to provide communications among host 500, ACC 520, MCC 530, and/or packet processing circuitry 540. Routing of communications among host 500, ACC 520, MCC 530, and/or packet processing circuitry 540 can be adjusted by a change of configuration.

Network interface device 510 can include multiple compute complexes, such as an Acceleration Compute Complex (ACC) 520 and Management Compute Complex (MCC) 530, as well as packet processing circuitry 540 and network interface technologies for communication with other devices via a network. ACC 520 can be implemented as one or more of: a microprocessor, processor, accelerator, field programmable gate array (FPGA), application specific integrated circuit (ASIC) or circuitry described at least with respect to other figures. Similarly, MCC 530 can be implemented as one or more of: a microprocessor, processor, accelerator, field programmable gate array (FPGA), application specific integrated circuit (ASIC) or circuitry described herein. In some examples, ACC 520 and MCC 530 can be implemented as separate cores in a CPU, different cores in different CPUs, different processors in a same integrated circuit, different processors in different integrated circuit.

Network interface device 510 can be implemented as one or more of: a microprocessor, processor, accelerator, field programmable gate array (FPGA), application specific integrated circuit (ASIC) or circuitry described herein. Packet processing pipeline circuitry 540 can process packets as directed or configured by one or more control planes executed by multiple compute complexes. In some examples, ACC 520 and MCC 530 can execute respective control planes 522 and 532.

SDN controller 550 can upgrade or reconfigure software executing on ACC 520 (e.g., control plane 522 and/or control plane 532) through contents of packets received through packet processing device 510. In some examples, ACC 520 can execute control plane operating system (OS) (e.g., Linux) and/or a control plane application 522 (e.g., user space or kernel modules) used by SDN controller 550 to configure operation of packet processing pipeline 540. Control plane application 522 can incude Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 550 can communicate with ACC 520 using a remote procedure call (RPC) such as Google remote procedure call (gRPC) or other service and ACC 520 can convert the request to target specific protocol buffer (protobuf) request to MCC 530. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 550 can provide packet processing rules for performance by ACC 520. For example, ACC 520 can program table rules (e.g., header field match and corresponding action) applied by packet processing pipeline circuitry 540 based on change in policy and changes in VMs, containers, microservices, applications, or other processes. ACC 520 can be configured to provide network policy as flow cache rules into a table to configure operation of packet processing pipeline 540. For example, the ACC-executed control plane application 522 can configure rule tables applied by packet processing pipeline circuitry 540 with rules to define a traffic destination based on packet type and content. ACC 520 can program table rules (e.g., match-action) into memory accessible to packet processing pipeline circuitry 540 based on change in policy and changes in VMs.

For example, ACC 520 can execute a virtual switch such as vSwitch or Open vSwitch (OVS), Stratum, or Vector Packet Processing (VPP) that provides communications between virtual machines executed by host 500 or with other devices connected to a network. For example, ACC 520 can configure packet processing pipeline circuitry 540 as to which VM is to receive traffic and what kind of traffic a VM can transmit. For example, packet processing pipeline circuitry 540 can execute a virtual switch such as vSwitch or Open vSwitch that provides communications between virtual machines executed by host 500 and packet processing device 510.

MCC 530 can execute a host management control plane, global resource manager, and perform hardware registers configuration. Control plane 532 executed by MCC 530 can perform provisioning and configuration of packet processing circuitry 540. For example, a VM executing on host 500 can utilize packet processing device 510 to receive or transmit packet traffic. MCC 530 can execute boot, power, management, and manageability software (SW) or firmware (FW) code to boot and initialize the packet processing device 510, manage the device power consumption, provide connectivity to a management controller (e.g., Baseboard Management Controller (BMC)), and other operations.

One or both control planes of ACC 520 and MCC 530 can define traffic routing table content and network topology applied by packet processing circuitry 540 to select a path of a packet in a network to a next hop or to a destination network-connected device. For example, a VM executing on host 500 can utilize packet processing device 510 to receive or transmit packet traffic.

ACC 520 can execute control plane drivers to communicate with MCC 530. At least to provide a configuration and provisioning interface between control planes 522 and 532, communication interface 525 can provide control-plane-to-control plane communications. Control plane 532 can perform a gatekeeper operation for configuration of shared resources. For example, via communication interface 525, ACC control plane 522 can communicate with control plane 532 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 525 can be utilized by a negotiation protocol and configuration protocol running between ACC control plane 522 and MCC control plane 532. Communication interface 525 can include a general purpose mailbox for different operations performed by packet processing circuitry 540. Examples of operations of packet processing circuitry 540 include issuance of non-volatile memory express (NVMe) reads or writes, issuance of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 525 can include one or more mailboxes accessible as registers or memory addresses. For communications from control plane 522 to control plane 532, communications can be written to the one or more mailboxes by control plane drivers 524. For communications from control plane 532 to control plane 522, communications can be written to the one or more mailboxes. Communications written to mailboxes can include descriptors which include message opcode, message error, message parameters, and other information. Communications written to mailboxes can include defined format messages that convey data.

Communication interface 525 can provide communications based on writes or reads to particular memory addresses (e.g., dynamic random access memory (DRAM)), registers, other mailbox that is written-to and read-from to pass commands and data. To provide for secure communications between control planes 522 and 532, registers and memory addresses (and memory address translations) for communications can be available only to be written to or read from by control planes 522 and 532 or cloud service provider (CSP) software executing on ACC 520 and device vendor software, embedded software, or firmware executing on MCC 530. Communication interface 525 can support communications between multiple different compute complexes such as from host 500 to MCC 530, host 500 to ACC 520, MCC 530 to ACC 520, baseboard management controller (BMC) to MCC 530, BMC to ACC 520, or BMC to host 500.

Packet processing circuitry 540 can be implemented using one or more of: application specific integrated circuit (ASIC), field programmable gate array (FPGA), processors executing software, or other circuitry. Control plane 522 and/or 532 can configure packet processing pipeline circuitry 540 or other processors to perform operations related to one or more of: storage access (e.g., NVMe or NVMe-oF reads or writes), lookaside crypto Engine (LCE), Address Translation Engine (ATE), local area network (LAN), remote direct memory access (RDMA), compression/decompression, encryption/decryption, or other accelerated operations.

Various message formats can be used to configure ACC 520 or MCC 530. In some examples, a P4 program can be compiled and provided to MCC 530 to configure packet processing circuitry 540. The following is a JSON configuration file that can be transmitted from ACC 520 to MCC 530 to get capabilities of packet processing circuitry 540 and/or other circuitry in packet processing device 510. More particularly, the file can be used to specify a number of transmit queues, number of receive queues, number of supported traffic classes (TC), number of available interrupt vectors, number of available virtual ports and the types of the ports, size of allocated memory, supported parser profiles, exact match table profiles, packet mirroring profiles, among others.

FIG. 5B depicts an example network interface device system. Various examples of packet processing device or network interface device 510 can utilize components described with respect to other figures. In some examples, packet processing device or network interface device can refer to one or more of: a network interface controller (NIC), a remote direct memory access (RDMA)-enabled NIC, SmartNIC, router, switch, forwarding element, infrastructure processing unit (IPU), or data processing unit (DPU). Network subsystem 560 can be communicatively coupled to compute complex 580. Network subsystem 560 can perform rate control at least for transmission of RoCEv2 packets based on information received from IFA probe response packets, as described herein.

Device interface 562 can provide an interface to communicate with a host system (not depicted). Various examples of device interface 562 can utilize protocols based on Peripheral Component Interconnect Express (PCIe), Compute Express Link (CXL), or others as well as virtual device interface such as virtual device interfaces. Peripheral Component Interconnect express (PCIe) is described at least in Peripheral Component Interconnect (PCI) Express Base Specification 1.0 (2002), as well as earlier versions, later versions, and variations thereof. Compute Express Link (CXL) is described at least in Compute Express Link Specification revision 2.0, version 0.7 (2019), as well as earlier versions, later versions, and variations thereof.

Interfaces 564 can initiate and terminate at least offloaded remote direct memory access (RDMA) operations, Non-volatile memory express (NVMe) reads or writes operations, and LAN operations. Packet processing pipeline 566 can perform packet processing (e.g., packet header and/or packet payload) based on a configuration and support quality of service (QoS) and telemetry reporting. Inline processor 568 can perform offloaded encryption or decryption of packet communications (e.g., Internet Protocol Security (IPSec) or others). Traffic shaper 570 can schedule transmission of communications. Network interface 572 can provide an interface at least to an Ethernet network by media access control (MAC) and serializer/de-serializer (Serdes) operations.

Cores 582 can be configured to perform infrastructure operations such as storage initiator, Transport Layer Security (TLS) proxy, virtual switch (e.g., vSwitch), or other operations. Memory 584 can store applications and data to be performed or processed. Offload circuitry 586 can perform at least cryptographic and compression operations for host or use by compute complex 580. Offload circuitry 586 can include one or more graphics processing units (GPUs) that can access memory 584. Management complex 588 can perform secure boot, life cycle management and management of network subsystem 560 and/or compute complex 580.

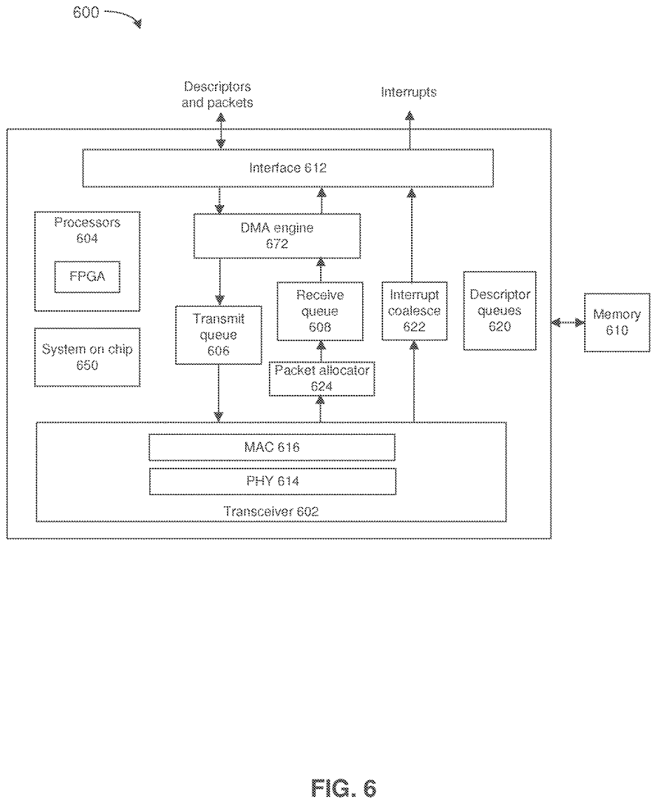

FIG. 6 depicts an example network interface device or packet processing device. In some examples, packet processing device 600 can be implemented as a network interface controller, network interface card, a host fabric interface (HFI), or host bus adapter (HBA), and such examples can be interchangeable. Packet processing device 600 can be coupled to one or more servers using a bus, PCIe, CXL, or Double Data Rate (DDR). Packet processing device 600 may be embodied as part of a system-on-a-chip (SoC) that includes one or more processors, or included on a multichip package that also contains one or more processors. Packet processing device 600 can perform rate control at least for transmission of RoCEv2 packets based on information received from IFA probe response packets, as described herein.

Some examples of packet processing device 600 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 600 can include transceiver 602, processors 604, transmit queue 606, receive queue 608, memory 610, and host interface 612, and DMA engine 652. Transceiver 602 can be capable of receiving and transmitting packets in conformance with the applicable protocols such as Ethernet as described in IEEE 802.3, although other protocols may be used. Transceiver 602 can receive and transmit packets from and to a network via a network medium (not depicted). Transceiver 602 can include PHY circuitry 614 and media access control (MAC) circuitry 616. PHY circuitry 614 can include encoding and decoding circuitry (not shown) to encode and decode data packets according to applicable physical layer specifications or standards. MAC circuitry 616 can be configured to assemble data to be transmitted into packets, that include destination and source addresses along with network control information and error detection hash values.

System on chip (SoC) 650 and processors 604 can include any a combination of: processor, core, graphics processing unit (GPU), field programmable gate array (FPGA), application specific integrated circuit (ASIC), or other programmable hardware device that allow programming of network interface 600. For example, a “smart network interface” can provide packet processing capabilities in the network interface using processors 604.

Processors 604 can include one or more packet processing pipeline that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 604, including its data plane, can be programmed based on one or more of: Protocol-independent Packet Processors (P4), Software for Open Networking in the Cloud (SONiC), Broadcom® Network Programming Language (NPL), NVIDIA® CUDA®, NVIDIA® DOCA™, Infrastructure Programmer Development Kit (IPDK), among others.

Packet allocator 624 can provide distribution of received packets for processing by multiple CPUs or cores using timeslot allocation described herein or RSS. When packet allocator 624 uses RSS, packet allocator 624 can calculate a hash or make another determination based on contents of a received packet to determine which CPU or core is to process a packet.

Interrupt coalesce 622 can perform interrupt moderation whereby network interface interrupt coalesce 622 waits for multiple packets to arrive, or for a time-out to expire, before generating an interrupt to host system to process received packet(s). Receive Segment Coalescing (RSC) can be performed by network interface 600 whereby portions of incoming packets are combined into segments of a packet. Network interface 600 provides this coalesced packet to an application.

Direct memory access (DMA) engine 652 can copy a packet header, packet payload, and/or descriptor directly from host memory to the network interface or vice versa, instead of copying the packet to an intermediate buffer at the host and then using another copy operation from the intermediate buffer to the destination buffer.

Memory 610 can be any type of volatile or non-volatile memory device and can store any queue or instructions used to program network interface 600. Transmit queue 606 can include data or references to data for transmission by network interface. Receive queue 608 can include data or references to data that was received by network interface from a network. Descriptor queues 620 can include descriptors that reference data or packets in transmit queue 606 or receive queue 608. Host interface 612 can provide an interface with host device (not depicted). For example, host interface 612 can be compatible with PCI, PCI Express, PCI-x, Serial ATA, and/or USB compatible interface (although other interconnection standards may be used). In some examples, network interface 600 can access memory 610 on a separate integrated circuit, or memory 610 can be integrated into a same integrated circuit as that of network interface 600.

FIG. 7 depicts a system. System 700 includes processor 710, which provides processing, operation management, and execution of instructions for system 700. Processor 710 can include any type of microprocessor, central processing unit (CPU), graphics processing unit (GPU), XPU, processing core, or other processing hardware to provide processing for system 700, or a combination of processors. An XPU can include one or more of: a CPU, a graphics processing unit (GPU), general purpose GPU (GPGPU), and/or other processing units (e.g., accelerators or programmable or fixed function FPGAs). Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 710 can include multiple processors and multiple processors can be embodied as processor sockets.

In one example, system 700 includes interface 712 coupled to processor 710, which can represent a higher speed interface or a high throughput interface for system components, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a programmable or fixed function offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 742 can provide multiple neural networks, CPUs, processor cores, general purpose graphics processing units, or graphics processing units can be made available for use by artificial intelligence (AI) or machine learning (ML) models. For example, the artificial intelligence (AI) model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

Applications 734 and/or processes 736 can refer instead or additionally to a virtual machine (VM), container (e.g., Docker container), microservice, processor, or other software. Various examples described herein can perform an application composed of microservices, where a microservice runs in its own process and communicates using protocols (e.g., application programming interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 732 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

Configuration of network interface device 750 can be consistent with versions of Network Driver Interface Specification (NDIS), Network Adapter Class Extension (NetAdapterCx), or others. For example, network interface device 750 can advertise capabilities transmit an IFA probe packet and process responses from IFA probe responses to selectively adjust a congestion window size. OS 732 or a driver can enable or disable the capabilities by calling an API.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers, workstations, or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. In some examples, packet processing device or network interface device 750 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, system 700 includes one or more input/output (I/O) interface(s) 760. I/O interface 760 can include one or more interface components through which a user interacts with system 700. Peripheral interface 770 can include any hardware interface not specifically mentioned above. Peripherals refer generally to devices that connect dependently to system 700.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 700 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. Die-to-die communications can utilize Embedded Multi-Die Interconnect Bridge (EMIB) or an interposer. Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: an SoC, one or more tiles, or other circuitry.

In an example, system 700 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples and includes an apparatus that includes: a network interface device that includes: a host interface; a network interface; a direct memory access (DMA) circuitry; and circuitry, wherein the circuitry is to control a transmission rate of packets based on a transmitted Inband Flow Analyzer (IFA) probe packet and a received IFA probe response packet, wherein the IFA probe response packet includes information utilized to control the transmission rate of packets and wherein the packets are transmitted in a manner consistent with a protocol that does not specify use of explicit acknowledgements of receipt (ACKs) and does not specify use of congestion windows.

Example 2 includes one or more earlier or later examples, wherein the IFA probe packets are consistent at least with Internet Engineering Task Force, “Inband Flow Analyzer” (2024).

Example 3 includes one or more earlier or later examples, wherein the information utilized to control the transmission rate of packets comprises one or more of: forwarding element queue depth, per-hop latency, or payload bytes not yet received by an endpoint receiver.

Example 4 includes one or more earlier or later examples, wherein the circuitry is to control the transmission rate of packets based on a count of transmitted data, a timestamp of transmission of the IFA probe packet, and a timestamp of receipt of the IFA probe response packet.

Example 5 includes one or more earlier or later examples, wherein the protocol comprises Remote Direct Memory Access (RDMA) over Converged Ethernet (RoCEv2) protocol and wherein the information utilized to control the transmission rate of packets is to indicate congestion in a path of the packets through one or more forwarding elements to an endpoint receiver network interface device.

Example 6 includes one or more earlier or later examples, wherein the information utilized to control the transmission rate of packets comprises a count of data transmitted from the network interface device and a timestamp of transmission of the IFA probe packet.

Example 7 includes one or more earlier or later examples, wherein: the circuitry is to increase the transmission rate of packets based on a decreasing number of payload bytes transmitted to an endpoint receiver network interface device and not received by the endpoint receiver network interface device and the circuitry is to decrease the transmission rate of packets based on an increasing number of payload bytes transmitted to the endpoint receiver network interface device and not received by the endpoint receiver network interface device.

Example 8 includes one or more earlier or later examples, wherein: the circuitry is to: determine a round trip time (RTT) value, increase the packet transmission rate based on a reduction in the RTT value compared to a prior RTT value, and decrease the packet transmission rate based on an increase in the RTT value compared to the prior RTT value.

Example 9 includes one or more earlier or later examples, and includes at least one non-transitory computer-readable medium, comprising instructions stored thereon, that if executed by one or more processors, cause the one or more processors to: configure a network interface device to: indicate a capability to control a transmission rate of packets based on a received Inband Flow Analyzer (IFA) probe response packet that includes information to control the transmission rate of packets and based on a request to perform the capability, enable the capability in the network interface device, wherein: the IFA probe response packet is a response to a transmitted IFA probe packet, the network interface device comprises: a host interface, direct memory access (DMA) circuitry, and a network interface, and the network interface device is to adjust the transmission rate of packets based on the information.

Example 10 includes one or more earlier or later examples, wherein the IFA probe packet is consistent at least with Internet Engineering Task Force, “Inband Flow Analyzer” (2024).

Example 11 includes one or more earlier or later examples, wherein: the packets are transmitted in a manner consistent with Remote Direct Memory Access (RDMA) over Converged Ethernet (RoCEv2) protocol and the information utilized to control the transmission rate of packets is to indicate congestion in a path of the packets through one or more forwarding elements to an endpoint receiver network interface device.

Example 12 includes one or more earlier or later examples, wherein the information to control the transmission rate of packets comprises a count of data transmitted from the network interface device and a timestamp of transmission of the IFA probe packet.

Example 13 includes one or more earlier or later examples, wherein the information to control the transmission rate of packets comprises one or more of: a forwarding element queue depth, per-hop latency, or payload bytes not yet received by an endpoint receiver network interface device.

Example 14 includes one or more earlier or later examples, and instructions stored thereon, that if executed by one or more processors, cause the one or more processors to: configure the network interface device to: increase the packet transmission rate based on a decreasing number of payload bytes transmitted to an endpoint receiver network interface device and not received by the endpoint receiver network interface device and reduce the packet transmission rate based on an increasing number of payload bytes transmitted to the endpoint receiver network interface device and not received by the endpoint receiver network interface device.

Example 15 includes one or more earlier or later examples, and instructions stored thereon, that if executed by one or more processors, cause the one or more processors to: configure the network interface device to: determine a round trip time (RTT) value, increase the packet transmission rate based on a decrease in the RTT value compared to a prior RTT value, and decrease the packet transmission rate based on an increase in the RTT value compared to a prior RTT value.

Example 16 includes one or more earlier or later examples, and includes a method comprising: controlling, by a network interface device, a transmission rate of packets based on a received Inband Flow Analyzer (IFA) probe response packet that includes information for window-based congestion control, wherein the IFA probe response packet are in response to a IFA probe packet and wherein the packets are transmitted in a manner consistent with a protocol that does not specify use of explicit acknowledgements of receipt (ACKs) and does not specify use of congestion windows.

Example 17 includes one or more earlier or later examples, wherein the IFA probe packet is consistent at least with Internet Engineering Task Force, “Inband Flow Analyzer” (2024) and the information for window-based congestion control indicates congestion in a path of the packets through one or more forwarding elements to an endpoint receiver network interface device and comprising: transmitting the packets to the endpoint receiver network interface device in a manner consistent with Remote Direct Memory Access (RDMA) over Converged Ethernet (RoCEv2) protocol.

Example 18 includes one or more earlier or later examples, wherein the information for window-based congestion control comprises one or more of: forwarding element queue depth, per-hop latency, payload bytes not yet received by an endpoint receiver network interface device, forwarding element queue depth, per-hop latency, or payload bytes not yet received by the endpoint receiver network interface device.

Example 19 includes one or more earlier or later examples, wherein the controlling the transmission rate of packets comprises controlling the transmission rate of packets based on a count of transmitted data, a timestamp of transmission of the IFA probe packet, and a timestamp of receipt of the IFA probe response packet.

Example 20 includes one or more earlier examples, and includes determining a round trip time (RTT) value based on the timestamp of transmission of the IFA probe packet and the timestamp of receipt of the IFA probe response packet, wherein the controlling the transmission rate of packets comprises controlling the transmission rate of packets based on a change in the RTT value compared to a prior measured RTT value.

1. An apparatus comprising:
a network interface device comprising:
a host interface;
direct memory access (DMA) circuitry;
a network interface; and
circuitry to control a transmission rate of packets based on a transmitted Inband Flow Analyzer (IFA) probe packet and a received IFA probe response packet, wherein the IFA probe response packet includes information utilized to control the transmission rate of packets and wherein the packets are transmitted in a manner consistent with a protocol that does not specify use of explicit acknowledgements of receipt (ACKs) and does not specify use of congestion windows.

2. The apparatus of claim 1, wherein the IFA probe packets are consistent at least with Internet Engineering Task Force, “Inband Flow Analyzer” (2024).

3. The apparatus of claim 1, wherein the information utilized to control the transmission rate of packets comprises one or more of: forwarding element queue depth, per-hop latency, or payload bytes not yet received by an endpoint receiver.

4. The apparatus of claim 1, wherein the circuitry is to control the transmission rate of packets based on a count of transmitted data, a timestamp of transmission of the IFA probe packet, and a timestamp of receipt of the IFA probe response packet.

5. The apparatus of claim 1, wherein the protocol comprises Remote Direct Memory Access (RDMA) over Converged Ethernet (RoCEv2) protocol and wherein the information utilized to control the transmission rate of packets is to indicate congestion in a path of the packets through one or more forwarding elements to an endpoint receiver network interface device.

6. The apparatus of claim 1, wherein the information utilized to control the transmission rate of packets comprises a count of data transmitted from the network interface device and a timestamp of transmission of the IFA probe packet.

7. The apparatus of claim 6, wherein:
the circuitry is to increase the transmission rate of packets based on a decreasing number of payload bytes transmitted to an endpoint receiver network interface device and not received by the endpoint receiver network interface device and
the circuitry is to decrease the transmission rate of packets based on an increasing number of payload bytes transmitted to the endpoint receiver network interface device and not received by the endpoint receiver network interface device.

8. The apparatus of claim 7, wherein:
the circuitry is to:
determine a round trip time (RTT) value,
increase the packet transmission rate based on a reduction in the RTT value compared to a prior RTT value, and
decrease the packet transmission rate based on an increase in the RTT value compared to the prior RTT value.

9. At least one non-transitory computer-readable medium, comprising instructions stored thereon, that if executed by one or more processors, cause the one or more processors to:
configure a network interface device to:
indicate a capability to control a transmission rate of packets based on a received Inband Flow Analyzer (IFA) probe response packet that includes information to control the transmission rate of packets and
based on a request to perform the capability, enable the capability in the network interface device, wherein:
the IFA probe response packet is a response to a transmitted IFA probe packet,
the network interface device comprises: a host interface, direct memory access (DMA) circuitry, and a network interface, and
the network interface device is to adjust the transmission rate of packets based on the information.

10. The computer-readable medium of claim 9, wherein the IFA probe packet is consistent at least with Internet Engineering Task Force, “Inband Flow Analyzer” (2024).

11. The computer-readable medium of claim 9, wherein:
the packets are transmitted in a manner consistent with Remote Direct Memory Access (RDMA) over Converged Ethernet (RoCEv2) protocol and
the information utilized to control the transmission rate of packets is to indicate congestion in a path of the packets through one or more forwarding elements to an endpoint receiver network interface device.

12. The computer-readable medium of claim 9, wherein the information to control the transmission rate of packets comprises a count of data transmitted from the network interface device and a timestamp of transmission of the IFA probe packet.

13. The computer-readable medium of claim 9, wherein the information to control the transmission rate of packets comprises one or more of: a forwarding element queue depth, per-hop latency, or payload bytes not yet received by an endpoint receiver network interface device.

14. The computer-readable medium of claim 9, comprising instructions stored thereon, that if executed by one or more processors, cause the one or more processors to:
configure the network interface device to:
increase the packet transmission rate based on a decreasing number of payload bytes transmitted to an endpoint receiver network interface device and not received by the endpoint receiver network interface device and
reduce the packet transmission rate based on an increasing number of payload bytes transmitted to the endpoint receiver network interface device and not received by the endpoint receiver network interface device.

15. The computer-readable medium of claim 14, comprising instructions stored thereon, that if executed by one or more processors, cause the one or more processors to:
configure the network interface device to:
determine a round trip time (RTT) value,
increase the packet transmission rate based on a decrease in the RTT value compared to a prior RTT value, and
decrease the packet transmission rate based on an increase in the RTT value compared to a prior RTT value.

16. A method comprising:
controlling, by a network interface device, a transmission rate of packets based on a received Inband Flow Analyzer (IFA) probe response packet that includes information for window-based congestion control, wherein the IFA probe response packet are in response to a IFA probe packet and wherein the packets are transmitted in a manner consistent with a protocol that does not specify use of explicit acknowledgements of receipt (ACKs) and does not specify use of congestion windows.

17. The method of claim 16, wherein the IFA probe packet is consistent at least with Internet Engineering Task Force, “Inband Flow Analyzer” (2024) and the information for window-based congestion control indicates congestion in a path of the packets through one or more forwarding elements to an endpoint receiver network interface device and comprising:
transmitting the packets to the endpoint receiver network interface device in a manner consistent with Remote Direct Memory Access (RDMA) over Converged Ethernet (RoCEv2) protocol.

18. The method of claim 16, wherein the information for window-based congestion control comprises one or more of: forwarding element queue depth, per-hop latency, payload bytes not yet received by an endpoint receiver network interface device, forwarding element queue depth, per-hop latency, or payload bytes not yet received by the endpoint receiver network interface device.

19. The method of claim 16, wherein the controlling the transmission rate of packets comprises controlling the transmission rate of packets based on a count of transmitted data, a timestamp of transmission of the IFA probe packet, and a timestamp of receipt of the IFA probe response packet.

20. The method of claim 19, comprising:
determining a round trip time (RTT) value based on the timestamp of transmission of the IFA probe packet and the timestamp of receipt of the IFA probe response packet, wherein the controlling the transmission rate of packets comprises controlling the transmission rate of packets based on a change in the RTT value compared to a prior measured RTT value.
